(19) United States
(12) Patent Application Publication
(10) Pub. No.: US 2023/0419604 A1
(43) Pub. Date: Dec. 28, 2023

(54) INFORMATION PROCESSING APPARATUS, INFORMATION PROCESSING METHOD, AND RECORDING MEDIUM

(71) Applicant: NEC Corporation, Minato-ku, Tokyo (JP)

(72) Inventors: Shizuo SAKAMOTO, Tokyo (JP); Kouki Miyamoto, Tokyo (JP)

(73) Assignee: NEC Corporation, Minato-ku, Tokyo (JP)

(21) Appl. No.: 18/038,286

(22) PCT Filed: Oct. 20, 2021
(86) PCT No.: PCT/JP2021/038810

§ 371 Date: May 23, 2023

(30) Foreign Application Priority Data
Nov. 30, 2020 (JP) 2020-198259

(51) Int. Cl. G06T 17/00

(52) U.S. Cl. CPC G06T 17/00

(57) ABSTRACT

An information processing apparatus including: an acquisition unit that obtains an image set including a plurality of images in which a subject is captured; a first storage unit that stores a plurality of image sets; a first selection unit that selects a first predetermined number of images from across the plurality of image sets; and a generation unit that generates a three-dimensional image of the subject on the basis of the first predetermined number of images. According to this information processing apparatus, it is possible to generate a three-dimensional image more properly.

### TECHNICAL FIELD

This disclosure relates to an information processing apparatus and an information processing method that generate a three-dimensional image, and a recording medium.

### BACKGROUND ART

A know apparatus of this type generates a three-dimensional image of a subject. For example, Patent Literature 1 discloses a technique/technology of creating a three-dimensional face model corresponding to a face image by mapping a value of each pixel of the face image on aligned three-dimensional face shape data. Patent Literature 2 discloses that a three-dimensional shape of a face of a target person is estimated and an estimated result is displayed on a display apparatus.

As another related technique/technology, for example, Patent Literature 3 discloses that distributed processing is performed for a process related to a three-dimensional object. Patent Literature 4 discloses that a forwarding load and a processing load are reduced by thinning out an image that is a processing target.

### CITATION LIST

### Patent Literature

Patent Literature 1: JP2011-209916A
Patent Literature 2: International Publication No. WO2019/078310
Patent Literature 3: JPH03-085688A
Patent Literature 4: JP2009-207709A

### SUMMARY

### Technical Problem

This disclosure aims to improve the related technique/technology described above.

### Solution to Problem

An information processing apparatus according to an example aspect of this disclosure includes: an acquisition unit that obtains an image set including a plurality of images in which a subject is captured; a first storage unit that stores a plurality of image sets; a first selection unit that selects a first predetermined number of images from across the plurality of image sets; and a generation unit that generates a three-dimensional image of the subject on the basis of the first predetermined number of images.

An information processing method according to an example aspect of this disclosure includes: obtaining an image set including a plurality of images in which a subject is captured; storing a plurality of image sets; selecting a first predetermined number of images from across the plurality of image sets; and generating a three-dimensional image of the subject on the basis of the first predetermined number of images.

A computer program according to an example aspect of this disclosure operates a computer: to obtain an image set including a plurality of images in which a subject is captured; to store a plurality of image sets; to select a first predetermined number of images from across the plurality of image sets; and to generate a three-dimensional image of the subject on the basis of the first predetermined number of images.

### BRIEF DESCRIPTION OF DRAWINGS

FIG. 1 is a block diagram illustrating a hardware configuration of an information processing apparatus according to a first example embodiment.

FIG. 2 is a block diagram illustrating a functional configuration of the information processing apparatus according to the first example embodiment.

FIG. 3 is a flowchart illustrating a flow of operation of the information processing apparatus according to the first example embodiment.

FIG. 4 is a conceptual diagram illustrating an example of selecting images in the information processing apparatus according to the first example embodiment.

FIG. 5 is a flowchart illustrating a flow of operation of an information processing apparatus according to a second example embodiment.

FIG. 6 is a schematic configuration diagram illustrating a configuration of an imaging system to which an information processing apparatus according to a third example embodiment is applied.

FIG. 7 is a plan view illustrating an example of a sinusoidal pattern projected on a subject.

FIG. 8 is a plan view illustrating an example of a luminance gradient pattern projected on the subject.

FIG. 9 is a diagram illustrating an example of an image set used in the information processing apparatus according to the third example embodiment.

FIG. 10 is a block diagram illustrating a functional configuration of an information processing apparatus according to a fourth example embodiment.

FIG. 11 is a flowchart illustrating a flow of operation of the information processing apparatus according to the fourth example embodiment.

FIG. 12 is a conceptual diagram illustrating a configuration of an image ring memory and a three-dimensional image ring memory.

FIG. 13 is a flowchart illustrating a flow of operation of an imaging thread in the information processing apparatus according to the fourth example embodiment.

FIG. 14 is a flowchart illustrating a flow of operation of a three-dimensional image generation thread in the information processing apparatus according to the fourth example embodiment.

FIG. 15 is a flowchart illustrating a flow of operation of the three-dimensional image display thread in the information processing apparatus according to the fourth example embodiment.

FIG. 16 is a block diagram illustrating a functional configuration of an information processing apparatus according to a modified example of the fourth example embodiment.

FIG. 17 is a flowchart illustrating a flow of operation of the information processing apparatus according to the modified example of the fourth example embodiment.

FIG. 18 is a flowchart illustrating a flow of operation of an information processing apparatus according to a fifth example embodiment.

FIG. 19 is a diagram illustrating an example of a list of three-dimensional images by an information processing apparatus according to a sixth example embodiment.

FIG. 20 is a diagram illustrating an example of a display aspect in the information processing apparatus according to the sixth example embodiment.

FIG. 21 is a block diagram illustrating a functional configuration of an information processing apparatus according to a seventh example embodiment.

FIG. 22 is a flowchart illustrating a flow of operation of the information processing apparatus according to the seventh example embodiment.

FIG. 23 is a diagram illustrating an example of a display aspect in the information processing apparatus according to the seventh example embodiment.

FIG. 24 is a block diagram illustrating a functional configuration of an information processing apparatus according to an eighth example embodiment.

FIG. 25 is a flowchart illustrating a flow of operation of the information processing apparatus according to the eighth example embodiment.

### DESCRIPTION OF EXAMPLE EMBODIMENTS

Hereinafter, an information processing method, an information processing apparatus, a computer program, and a recording medium according to example embodiments will be described with reference to the drawings.

### First Example Embodiment

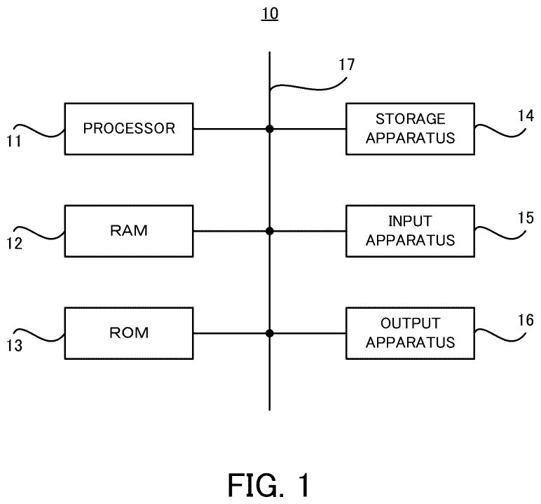

An information processing apparatus according to a first example embodiment will be described with reference to FIG. 1 to FIG. 4.

### (Hardware Configuration)

First, with reference to FIG. 1, a hardware configuration of the information processing apparatus according to the first example embodiment will be described. FIG. 1 is a block diagram illustrating the hardware configuration of the information processing apparatus according to the first example embodiment.

As illustrated in FIG. 1, an information processing apparatus 10 according to the first example embodiment includes a processor 11, a RAM (Random Access Memory) 12, a ROM (Read Only Memory) 13, and a storage apparatus 14. The information processing apparatus 10 may further include an input apparatus 15 and an output apparatus 16. The processor 11, the RAM 12, the ROM 13, the storage apparatus 14, the input apparatus 15, and the output apparatus 16 are connected through a data bus 17.

The processor 11 reads a computer program. For example, the processor 11 is configured to read a computer program stored by at least one of the RAM 12, the ROM 13 and the storage apparatus 14. Alternatively, the processor 11 may read a computer program stored in a computer-readable recording medium by using a not-illustrated recording medium reading apparatus. The processor 11 may obtain (i.e., may read) a computer program from a not-illustrated apparatus disposed outside the information processing apparatus 10, through a network interface. The processor 11 controls the RAM 12, the storage apparatus 14, the input apparatus 15, and the output apparatus 16 by executing the read computer program. Especially in this example embodiment, when the processor 11 executes the read computer program, a functional block for generating a three-dimensional image is realized or implemented in the processor 11. An example of the processor 11 includes a CPU (Central Processing Unit), a GPU (Graphics Processing Unit), a FPGA (field-programmable gate array), a DSP (Demand-Side Platform), and an ASIC (Application Specific Integrated Circuit). The processor 11 may use one of the above examples, or may use a plurality of them in parallel.

The RAM 12 temporarily stores the computer program to be executed by the processor 11. The RAM 12 temporarily stores the data that is temporarily used by the processor 11 when the processor 11 executes the computer program. The RAM 12 may be, for example, a D-RAM (Dynamic RAM).

The ROM 13 stores the computer program to be executed by the processor 11. The ROM 13 may otherwise store fixed data. The ROM 13 may be, for example, a P-ROM (Programmable ROM).

The storage apparatus 14 stores the data that is stored for a long term by the information processing apparatus 10. The storage apparatus 14 may operate as a temporary storage apparatus of the processor 11. The storage apparatus 14 may include, for example, at least one of a hard disk apparatus, a magneto-optical disk apparatus, a SSD (Solid State Drive), and a disk array apparatus.

The input apparatus 15 is an apparatus that receives an input instruction from a user of the information processing apparatus 10. The input apparatus 15 may include, for example, at least one of a keyboard, a mouse, and a touch panel. The input apparatus 15 may be a dedicated controller (operation terminal). The input apparatus 15 may also include a terminal owned by the user (e.g., a smartphone or a tablet terminal, etc.). The input apparatus 15 may be an apparatus that allows an audio input including a microphone, for example.

The output apparatus 16 is an apparatus that outputs information about the information processing apparatus 10 to the outside. For example, the output apparatus 16 may be a display apparatus (e.g., a display) that is configured to display the information about the information processing apparatus 10. The display apparatus here may be a TV monitor, a personal computer monitor, a smartphone monitor, a tablet terminal monitor, or another portable terminal monitor. The display apparatus may be a large monitor or a digital signage installed in various facilities such as stores. The output apparatus 16 may be an apparatus that outputs the information in a format other than an image. For example, the output apparatus 16 may be a speaker that audio-outputs the information about the information processing apparatus 10.

### (Functional Configuration)

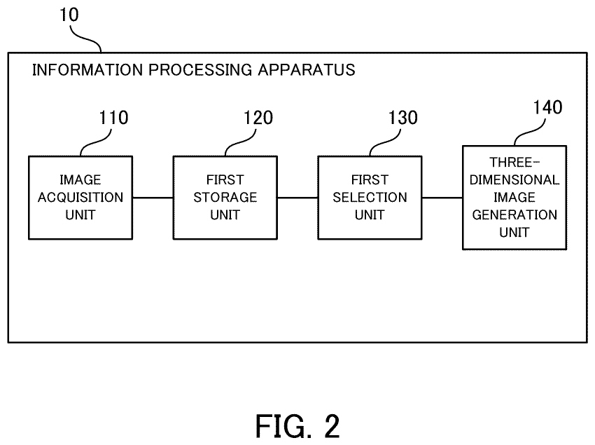

Next, a functional configuration of the information processing apparatus 10 according to the first example embodiment will be described with reference to FIG. 2. FIG. 2 is a block diagram illustrating the functional configuration of the information processing apparatus according to the first example embodiment.

As illustrated in FIG. 2, the information processing apparatus 10 according to the first example embodiment includes, as processing blocks for realizing the functions thereof, an image acquisition unit 110, a first storage unit 120, a first selection unit 130, and a three-dimensional image generation unit 140. Each of the image acquisition unit 110, the first selection unit 130, and the three-dimensional image generation unit 140 may be realized or implemented by the processor 11 (see FIG. 1). The first storage unit 120 may be realized or implemented by the RAM 12 (see FIG. 1).

The image acquisition unit 110 is configured to obtain an image set including a plurality of images in which a subject is captured. The image acquisition unit 110 may directly obtain an image captured by a camera or the like, for example, or may obtain an image stored in a storage unit as appropriate. When the image is obtained from the camera, a plurality of cameras may be used, and a plurality of images may be obtained respectively from the plurality of cameras. The number of the images included in the image set is not particularly limited. A specific example of the image set will be described in detail in another example embodiment described later. The images stored in the image acquisition unit 110 are configured to be outputted to the first storage unit 120.

The first storage unit 120 is configured to store a plurality of image sets (i.e., a plurality of images) obtained by the image acquisition unit 110. The first storage unit 120 is configured to store two image sets, for example. The first storage unit 120 may be configured to store three or more image sets. The first storage unit 120 may have a function of deleting an unnecessary image set as appropriate.

The first selection unit 130 is configured to select a first predetermined number of images from the image sets stored in the first storage unit 120. Here, the “first predetermined number” is set as the number of images to be outputted to the three-dimensional image generation unit 140, and may be a minimum required number to generate the three-dimensional image, for example. The first predetermined number may be the same as, or different from, the number of the images included in the image set. In particular, the first selection unit 130 selects the first predetermined number of images from across the plurality of image sets stored in the first storage unit 120. For example, the first selection unit 130 selects the first predetermined number of images from across a first image set and a second image set. A method of selecting the images by the first selection unit 130 will be described in detail later. The first predetermined number of images selected by the first selection unit 130 are configured to be outputted to the three-dimensional image generation unit 140.

The three-dimensional image generation unit 140 is configured to generate a three-dimensional image of the subject from the first predetermined number of images selected by the first selection unit 130. That is, the three-dimensional image generation unit 140 has a function of generating a three-dimensional image from a plurality of two-dimensional images. A method of generating the three-dimensional image from the plurality of images is not particularly limited, and the existing techniques/technologies may be adopted as appropriate. Therefore, a detailed explanation of the method will be omitted.

### (Flow of Operation)

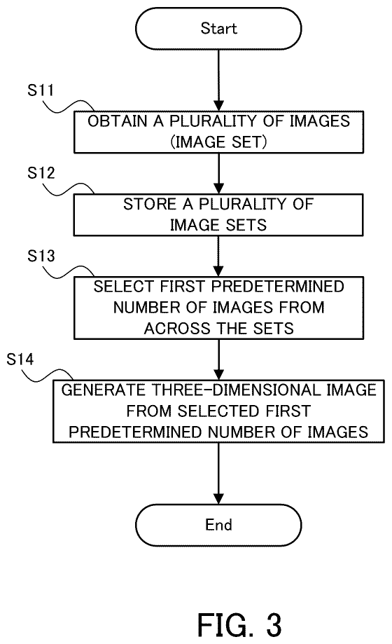

Next, a flow of operation of the information processing apparatus 10 according to the first example embodiment will be described with reference to FIG. 3. FIG. 3 is a flowchart illustrating the flow of the operation of the information processing apparatus according to the first example embodiment.

As illustrated in FIG. 3, in operation of the information processing apparatus 10 according to the first example embodiment, first, the image acquisition unit 110 obtains the image set including a plurality of images (step S11). Then, the first storage unit 120 stores the image set obtained by the image acquisition unit 110 (step S12). In the steps S11 and S12, a plurality of image sets may be collectively obtained and stored, or a plurality of image sets may be stored by repeatedly performing a process of obtaining and storing a single image set.

Subsequently, the first selection unit 130 selects the first predetermined number of images from across the plurality of image sets stored in the first storage unit 120 (step S13). Then, the three-dimensional image generation unit 140 generates the three-dimensional image of the subject by using the first predetermined number of images selected by the first selection unit 130 (step S14). A series of processing steps described above may be performed repeatedly as appropriate. In other words, a plurality of three-dimensional images may be generated by repeatedly performing a process of generating the three-dimensional image.

### (Example of Image Selection)

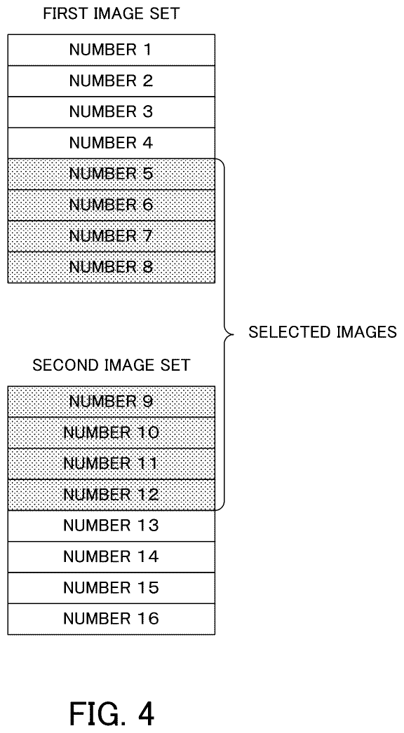

Next, with reference to FIG. 4, an example of selecting the images by the first selection unit 130. FIG. 4 is a conceptual diagram illustrating the example of selecting the images in the information processing apparatus according to the first example embodiment.

As illustrated in FIG. 4, it is assumed that the first image set and the second image set are stored in the first storage unit 120. A single image set includes eight images. Specifically, the first image includes eight images numbered 1 to 8. The second image set includes eight images numbered 9 to 16.

In this case, the first selection unit 130 may select, for example, four images in a latter half of the first image set (i.e., images numbered 5 to 8) and four images in a first half of the second image set (i.e., images numbered 9 to 12). In this situation, a three-dimensional image is generated from a total of selected eight images numbered 5 to 8, and from 9 to 12. In other words, unselected images (i.e., images numbered 1 to 4 and images numbered 13 to 16) are not used to generate the three-dimensional image. The unused images may be discarded, or may be used in a similar process that is performed at different times. (e.g., it may be a next selection candidate for the first selection unit 130).

In the above selection example, the images consecutively numbered across the sets (i.e., consecutive images numbered 5 to 12) are selected, but not-consecutively numbered images may be selected. For example, images numbered 1, 3, 5, and 7 in the first image set, and images numbered 9, 11, 13, and 15 in the second image set may be selected. In the above example, the same number of images (8 sheets) as that of the images included in the image set are selected, but a different number of images (e.g., 7 or less images, or 9 or more images) from that of the images included in the image set may be selected. The selected images may be set as appropriate in accordance with various conditions. The selected images may be determined on the basis of image quality (e.g., whether an imaging target is facing front, the image is not blurred, defocused, etc.), for example. Such examples will be described in detail in another example embodiment described later.

### (Technical Effect)

Next, a technical effect obtained by the information processing apparatus 10 according to the first example embodiment will be described.

As described in FIG. 1 to FIG. 4, in the information processing apparatus 10 according to the first example embodiment, the first predetermined number of images are selected from across the plurality of image sets. In this way, it is possible to generate the three-dimensional image by using the first predetermined number of images included in the different image sets. In this case, the three-dimensional image can be generated more properly than when the three-dimensional image is generated by using only the images included in a single image set. For example, it is possible to generate the three-dimensional image by selecting the images that are suitable for generating the three-dimensional image (in other words, by excluding images that are not suitable for generating the three-dimensional image).

Especially in the information processing apparatus 10 according to the first example embodiment, since it includes the first storage unit 120 that stores the plurality of image sets, it is easy to select the first predetermined number of images from across the sets. Furthermore, since the first storage unit 120 is configured to store the plurality of image sets, it is possible to efficiently perform the process of obtaining the images and the process of selecting the images and generating the three-dimensional image. Specifically, the process of obtaining the images and the process of generating the three-dimensional image may be performed at the same time in parallel. In addition, since the first storage unit 120 is provided, it is possible to perform the process of obtaining a new image, without waiting for the completion of the process of generating the three-dimensional image. If the first storage unit 120 is not provided, the image acquisition unit 110 is not allowed to obtain a new image until the three-dimensional image generation unit 140 completes the generation of the three-dimensional image by using the single image set (i.e., it is required to wait for the completion of the process of generating the three-dimensional image). By providing the first storage unit 120, however, the image acquisition unit 110 is allowed to obtain a new image without waiting for the completion of the process of generating the three-dimensional image that is performed by the three-dimensional image generation unit 140. Specifically, the image acquisition unit 110 may sequentially store the obtained image in the first storage unit 120, and the three-dimensional image generation unit 140 may obtain the images from the first storage unit 120 and may generate the three-dimensional image, without directly obtaining the images from the image acquisition unit 110.

### Second Example Embodiment

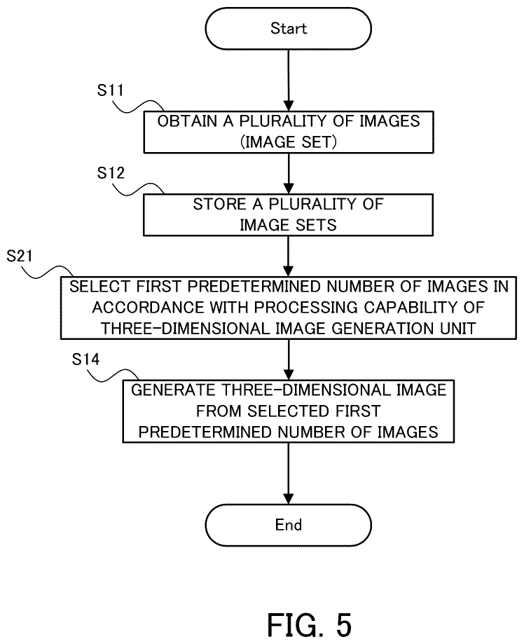

The information processing apparatus 10 according to a second example embodiment will be described with reference to FIG. 5. The second example embodiment is partially different from the first example embodiment only in the operation, and may be the same as the first example embodiment in the hardware configuration of the apparatus (see FIG. 1) and the functional configuration (see FIG. 2), for example. For this reason, a part that is different from the first example embodiment will be described in detail below, and a description of the other overlapping parts will be omitted as appropriate.

### (Flow of Operation)

First, with reference to FIG. 5, a flow of operation of the information processing apparatus according to the second example embodiment will be described. FIG. 5 is a flowchart illustrating the flow of the operation of the information processing apparatus according to the second example embodiment. In FIG. 5, the same steps as those illustrated in FIG. 3 carry the same reference numerals.

As illustrated in FIG. 5, in operation of the information processing apparatus 10 apparatus 10 according to the second example embodiment, first, the image acquisition unit 110 obtains the image set including a plurality of images (step S11). Then, the first storage unit 120 stores the image set obtained by the image acquisition unit 110 (step S12).

Subsequently, the first selection unit 130 selects the first predetermined number of images from across the plurality of image sets stored in the first storage unit 120. In this case, especially in the second example embodiment, the first selection unit 130 selects the first predetermined number of images in accordance with a processing capacity of the three-dimensional image generation unit 140 (step S21). That is, the first selection unit 130 selects the images in accordance with the subsequent processing capability. Then, the three-dimensional image generation unit 140 generates the three-dimensional image of the subject by using the first predetermined number of images selected by the first selection unit 130 (step S14).

The “processing capability of the three-dimensional image generation unit 140” described above may be a processing capability in specifications of the three-dimensional image generation unit 140, or may be a processing capability at that time point that takes into account a computational load of the process that is being executed. The first selection unit 130 changes the number of images to be selected (i.e., a value of the first predetermined number) in accordance with the processing capacity of the three-dimensional image generation unit 140, for example. In this case, the number of the images used by the three-dimensional image generation unit 140 to generate the three-dimensional image varies in accordance with the processing capacity. Alternatively, the first selection unit 130 changes a frequency of selecting the images in accordance with the processing capability of the three-dimensional image generation unit 140. In this case, the frequency of outputting the images to the three-dimensional image generation unit 140 varies, and consequently, the number of images processed per unit time by the three-dimensional image generation unit 140 varies.

### (Technical Effect)

Next, a technical effect obtained by the information processing apparatus 10 according to the second example embodiment will be described.

As described in FIG. 5, in the information processing apparatus 10 according to the second example embodiment, the first predetermined number of images are selected in accordance with the processing capacity of the three-dimensional image generation unit 140. In this way, it is possible to properly generate the three-dimensional image in view of the processing capability of the three-dimensional image generation unit 140. For example, when the processing capacity of the three-dimensional image generation unit 140 is dropping, the first selection unit 130 reduces the number of images to be selected. In this case, since the number of images processed at one time by the three-dimensional image generation unit 140 is reduced, even the three-dimensional image generation unit 140 with a reduced processing capacity is capable of successfully performing the process of generating the three-dimensional image. Alternatively, when the processing capacity of the three-dimensional image generation unit 140 is dropping, the first selection unit 130 selects the images less frequently. In this case, since the number of images processed per unit time by the three-dimensional image generation unit 140 is reduced, even the three-dimensional image generation unit 140 with a reduced processing capacity is capable of performing the process of generating the three-dimensional image without a problem.

### Third Example Embodiment

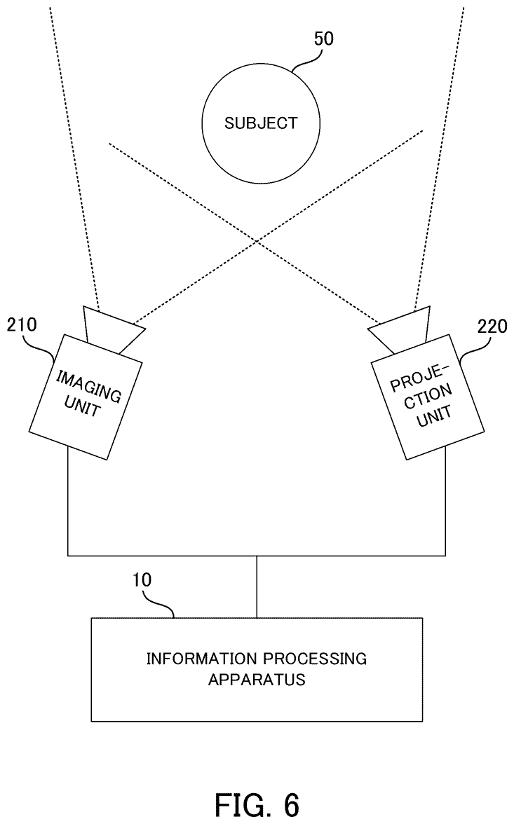

The information processing apparatus 10 according to a third example embodiment will be described with reference to FIG. 6 to FIG. 9. The third example embodiment shows a specific example of the images (i.e., the images of the subject for generating the three-dimensional image) used in the first and second example embodiments, and may be the same as the first and second example embodiments in the apparatus configuration, the flow of the operation, or the like. For this reason, a part that is different from each of the example embodiments described above will be described in detail below, and a description of the other overlapping parts will be omitted as appropriate.

### (Imaging System)

First, with reference to FIG. 6, an overall configuration of an imaging system including the information processing apparatus according to the third example embodiment will be described.

FIG. 6 is a schematic configuration diagram illustrating the configuration of the imaging system to which the information processing apparatus according to the third example embodiment is applied.

As illustrated in FIG. 6, the information processing apparatus 10 according to the third example embodiment is connected to an imaging unit 210 and a projection unit 220. Each of the imaging unit 210 and the projection unit 220 is disposed to face in a direction of a subject 50.

The imaging unit 210 is configured to capture an image of the subject 50. The imaging unit 210 may include a solid-state image sensing device, such as, for example, a CCD (Charge Coupled Device) image sensor and a CMOS (Complementary Metal Oxide Semiconductor) image sensor. Furthermore, the imaging unit 210 may include an optical system that forms an image of the subject on an imaging surface of the solid-state image sensing device, a signal processing circuit that obtains a luminance value of each pixel by signal processing of an output of the solid-state image sensing device, or the like. Here, for convenience of description, a single imaging unit 210 is illustrated, but two or more imaging units 210 may be provided. In this case, the two imaging units 210 may be arranged to capture the subject 50 at differing angles.

The projection unit 220 is configured to project a predetermined light pattern on the subject 50. The projection unit 220 is not particularly limited, but may be a DLP (Digital light Processing) projector, a liquid crystal projector, or the like, for example. The DLP projector and the liquid crystal projector are allowed to project an arbitrary light pattern at high speed, and are preferable in order to shorten a time to measure a shape of the objects 50. Shortening the measurement time is suitable for measuring a three-dimensional shape of an object in motion (a moving object), especially when facial authentication of a person is performed. Details of the light pattern that is projected by the projection unit 220 on the subject 50 will be described later.

### (Sinusoidal Pattern)

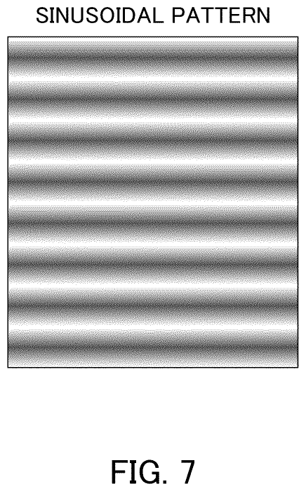

With reference to FIG. 7, a detailed description will be given to a sinusoidal pattern projected on the subject, and a measurement technique using the sinusoidal pattern. FIG. 7 is a plan view illustrating an example of the sinusoidal pattern projected on the subject.

As in the example illustrated in FIG. 7, the projection unit 220 projects a sinusoidal pattern (i.e., a sinusoidal grating light pattern) on the subject 50 as the predetermined light pattern. The projection of the sinusoidal pattern makes it possible to perform a three-dimensional shape measurement using a sinusoidal grating phase shift method. The sinusoidal grating phase shift method is a method of projecting the sinusoidal pattern on the subject while shifting its phase little by little, and of specifying the three-dimensional shape of the subject.

Hereinafter, a basic principle of the measurement technique using the sinusoidal grating phase shift method will be described. When the imaging unit 210 images the subject on which the sinusoidal pattern is projected, a luminance value I(x,y,t) at a time t at (x,y) coordinates of a resulting image may be expressed as the following equation (1), where an amplitude of a sine wave is A, a phase value is 0, and a bias (a center value of the sine wave) is B.

[Equation 1]

I(x,y,t)=A·cos(t+θ)+B (1)

Since the sinusoidal pattern projected by the projection unit 220 has a different phase value θ at each angle viewed from the projection unit 220, if the phase value θ at the coordinates (x,y) can be obtained, it is possible to determine a three-dimensional position corresponding to the coordinates (x,y).

There are three unknowns in the equation (1) that are the amplitude A, the phase value θ and the bias B, it is possible to calculate the phase value θ if there are a minimum of three sinusoidal-pattern projected images. When four or more light-pattern projected images are captured, it is possible to calculate the phase value θ with higher accuracy by a least squares method or the like.

Here, it is assumed that four sinusoidal patterns in which the phases are shifted by ¼ wavelengths are projected respectively at a time t=0, a time t=π/2, a time t=π, and a time t=3π/2 to obtain images. The luminance value I(x,y,t) at the coordinates (x,y) at each time can be expressed as the following equations (2) to (5).

$$\\ \begin{matrix}[ Equation 2 ] & \\ I ( x , y , 0 ) = A \cdot cos ( θ ) + B & ( 2 )\end{matrix}$$

$$\\ \begin{matrix}I ( x , y , \frac{π}{2} ) = A \cdot cos ( \frac{π}{2} + θ ) + B & ( 3 )\end{matrix}$$

$$\\ \begin{matrix}I ( x , y , π ) = A \cdot cos ( π + θ ) + B & ( 4 )\end{matrix}$$

$$\\ \begin{matrix}I ( x , y , \frac{3 π}{2} ) = A \cdot cos ( \frac{3 π}{2} + θ ) + B & ( 5 )\end{matrix}$$

The following equations (6) to (8) can be obtained by obtaining the amplitude A, the phase value θ, and the bias B from the equations (2) to (5) by the least squares method.

$$\\ \begin{matrix}[ Equation 3 ] & \\ A = \frac{\sqrt{{( I ( x , y , 0 ) - I ( x , y , π ) )}^{2} + {( I ( x , y , \frac{π}{2} ) - I ( x , y , \frac{3 π}{2} ) )}^{2}}}{2} & ( 6 )\end{matrix}$$

$$\\ \begin{matrix}B = \frac{I ( x , y , 0 ) + I ( x , y , \frac{π}{2} ) + I ( x , y , π ) + I ( x , y , \frac{3 π}{2} )}{4} & ( 7 )\end{matrix}$$

$$\\ \begin{matrix}θ = {tan}^{- 1} \frac{- I ( x , y , \frac{π}{2} ) + I ( x , y , \frac{3 π}{2} )}{I ( x , y , 0 ) - I ( x , y , π )} & ( 8 )\end{matrix}$$

### (Luminance Gradient Pattern)

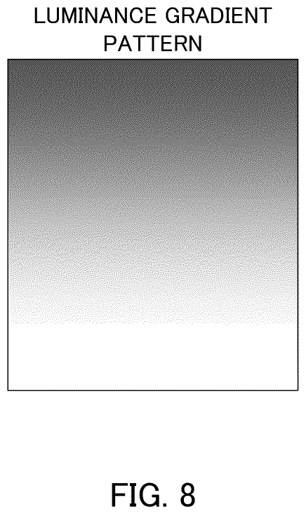

Next, with reference to FIG. 8, a detailed description will be given to a luminance gradient pattern projected on the subject, and a measurement technique using the luminance gradient pattern.

FIG. 8 is a plan view illustrating an example of the luminance gradient pattern projected on the subject.

As in the example illustrated in FIG. 8, the projection unit 220 projects a luminance gradient pattern (i.e., a light pattern in which the luminance value changes linearly at a constant rate) on the subject 50, in addition to the sinusoidal pattern described above. The luminance gradient pattern is projected as a periodic light pattern in which the number of repetition periods is different from those of the sinusoidal pattern. FIG. 8 illustrates the luminance gradient pattern that is brightened at a constant rate from top to bottom, but a luminance gradient pattern that is brightened at a constant rate from bottom to top may be also used, for example.

Hereinafter, the measurement technique using the luminance gradient pattern will be described. When the imaging unit 210 images the subject 50 on which the luminance gradient pattern is projected, a luminance value K(x,y,t) at a time t at (x,y) coordinates of a resulting image may be expressed as the following equation (9), where A″ is an amplitude, B″ is a bias, and o is a variable that changes linearly in a range of −1≤ω≤1.

[Equation 4]

K(x,y,t)=A″·(−(2t−1)·ω)+B″ (9)

Here, when the projector that is configured to project an arbitrary light pattern, such as a liquid crystal projector and a DLP projector, is used as the projection unit 220, the sinusoidal pattern and the luminance gradient pattern can be switched and projected by a single projection unit 220 at high speed. Then, when the single projection unit 220 projects the sinusoidal pattern and the luminance gradient pattern that are generated on the basis of a light emitted from a same light source, basic physical properties of the projection apparatus 20 at the time of projection of these light patterns may be assumed to be the same. That is, when the sinusoidal pattern and the luminance gradient pattern are projected on the subject 50 by the same projection unit 220, it is considered that the following equation (10) is satisfied.

A=A″,B=B″ (10)

When the subject 50 on which the luminance gradient pattern is projected, is imaged only once, the luminance value K(x,y,t) and the variable ω can be expressed as equations (11) and (12).

$$\\ \begin{matrix}[ Equation 5 ] & \\ K ( x , y , 0 ) = A \cdot ω + B & ( 11 )\end{matrix}$$

$$\\ \begin{matrix}ω = \frac{K ( x , y , 0 ) - B}{A} & ( 12 )\end{matrix}$$

Furthermore, the subject 50 on which the luminance gradient pattern is projected, may be imaged twice, and the variable ω may also be obtained by the least squares method. That is, when images are respectively obtained at a time t=0 and a time t=1, the luminance value K(x,y,t) at the coordinates (x,y) is expressed as in the following equations (13) and (14). The variable ω is expressed as the following equation (15).

$$\\ \begin{matrix}[ Equation 6 ] & \\ K ( x , y , 0 ) = A \cdot ω + B & ( 13 )\end{matrix}$$

$$\\ \begin{matrix}K ( x , y , 1 ) = - A \cdot ω + B & ( 14 )\end{matrix}$$

$$\\ \begin{matrix}ω = \frac{K ( x , y , 0 ) - K ( x , y , 1 )}{2 A} & ( 15 )\end{matrix}$$

### (Example of Image Set)

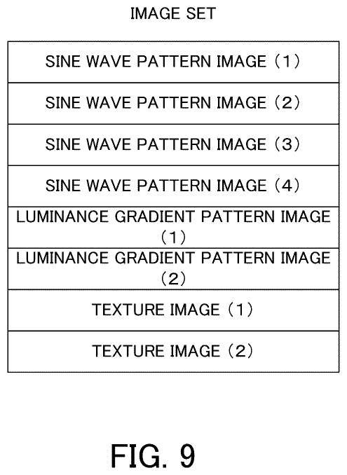

Next, with reference to FIG. 9, the image set obtained by the information processing apparatus 10 according to the third example embodiment will be described. FIG. 9 is a diagram illustrating an example of the image set used in the information processing apparatus according to the third example embodiment.

As illustrated in FIG. 9, the information processing apparatus 10 according to the third example embodiment obtains, as a single image set, a plurality of images including an image captured with the sinusoidal pattern (see FIG. 7) projected thereon, an image captured with the luminance gradient pattern (see FIG. 8) projected thereon, and a texture image indicating a state of a surface of the subject 50. In the example illustrated in FIG. 9, the single image set includes a total of eight images that are four images captured with the sinusoidal pattern projected thereon, two images captured with the luminance gradient pattern projected thereon, and two textured images.

The configuration of the image set described above is merely one example and the number of each of the images captured with the sinusoidal pattern projected thereon, the images captured with the luminance gradient pattern projected thereon, and the texture images may be changed as appropriate. In addition, a total number of the images that constitute the single image set may be different from eight. The single image set, however, preferably includes a plurality of images captured with the sinusoidal pattern projected thereon, a plurality of images captured with the luminance gradient pattern projected thereon, and a plurality of texture images.

### (Technical Effect)

Next, a technical effect obtained by the information processing apparatus 10 according to the third example embodiment will be described.

As described in FIG. 6 to FIG. 9, in the information processing apparatus 10 according to the third example embodiment, a plurality of images including the image captured with the sinusoidal pattern projected thereon, the image captured with the luminance gradient pattern projected thereon, and the texture image are obtained as the image set. In this way, it is possible to properly generate the three-dimensional image from each of the images included in the image set.

### Fourth Example Embodiment

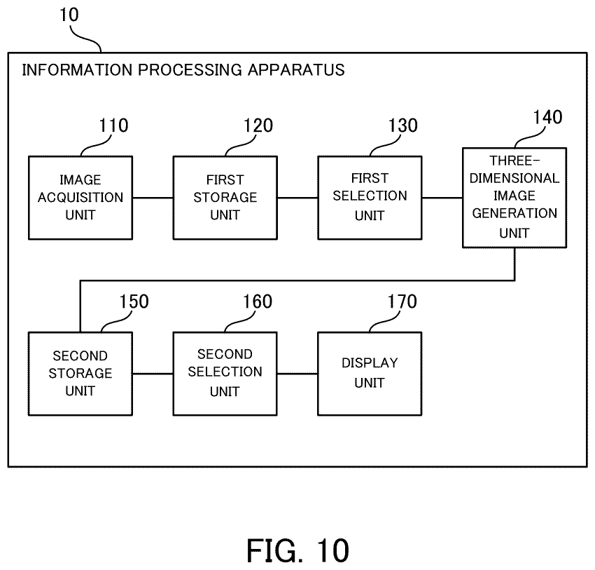

The information processing apparatus 10 according to a fourth example embodiment will be described with reference to FIG. 10 to FIG. 15. The fourth example embodiment is partially different from the first to third example embodiments only in the configuration and operation, and may be the same as the first to third example embodiments in other parts. For this reason, a part that is different from each of the example embodiments described above will be described in detail below, and a description of the other overlapping parts will be omitted as appropriate.

### (Functional Configuration)

First, with reference to FIG. 10, a functional configuration of the information processing apparatus 10 according to the fourth example embodiment will be described. FIG. 10 is a block diagram illustrating the functional configuration of the information processing apparatus according to the fourth example embodiment. In FIG. 10, the same components as those illustrated in FIG. 2 carry the same reference numerals.

As illustrated in FIG. 10, the information processing apparatus 10 according to the fourth example embodiment includes, as processing blocks for realizing the functions thereof, the image acquisition unit 110, the first storage unit 120, the first selection unit 130, the three-dimensional image generation unit 140, a second storage unit 150, a second selection unit 160, and a display unit 170. That is, the information processing apparatus 10 according to the fourth example embodiment further includes the second storage unit 150, the second selection unit 160, and the display unit 170, in addition to the configuration (see FIG. 2) in the first example embodiment. The second storage unit 150 may be realized or implemented by the RAM 12 (see FIG. 1). The second selection unit 160 and the display unit 170 may be realized or implemented by the processor 11 (see FIG. 1).

The second storage unit 150 is configured to store a plurality of sets (hereinafter referred to as a “three-dimensional image sets” as appropriate) each of which includes a plurality of three-dimensional images generated by the three-dimensional image generation unit 140. The second storage unit 150 is configured to store two three-dimensional image sets, for example. The second storage unit 150 may be configured to store three or more three-dimensional image sets. The second storage unit 150 may have a function of deleting an unnecessary three-dimensional image set as appropriate.

The second selection unit 160 is configured to selecting a second predetermined number of three-dimensional images from the three-dimensional image sets stored in the second storage unit 150. The “second predetermined number” here is set as the number of three-dimensional images to be outputted by the display unit 170, and may be the number of three-dimensional images to be displayed at the same time on a display or the like, for example. The second predetermined number may be the same as, or different from, the number of the three-dimensional images included in the three-dimensional image set. In particular, the second selection unit 160 selects the second predetermined number of three-dimensional images from across a plurality of three-dimensional image sets stored in the second storage unit 150. For example, the second selection unit 160 selects the second predetermined number of images from across a first three-dimensional image set and a second three-dimensional image set. The second predetermined number of three-dimensional images selected by the second selection unit 160 is configured to be outputted to the display unit 170.

The display unit 170 outputs the second predetermined number of images selected by the second selection unit 160, as the three-dimensional images to be displayed to the user or the like. That is, the display unit 170 has a function of outputting a plurality of three-dimensional images. The three-dimensional images outputted from the display unit 170 are output to a display apparatus with a display, for example. This display apparatus may be realized or implemented by the output apparatus 16 (see FIG. 1), for example. A display aspect of the three-dimensional images outputted from the display unit 170 will be described with a specific example in another example embodiment described later.

### (Flow of Operation)

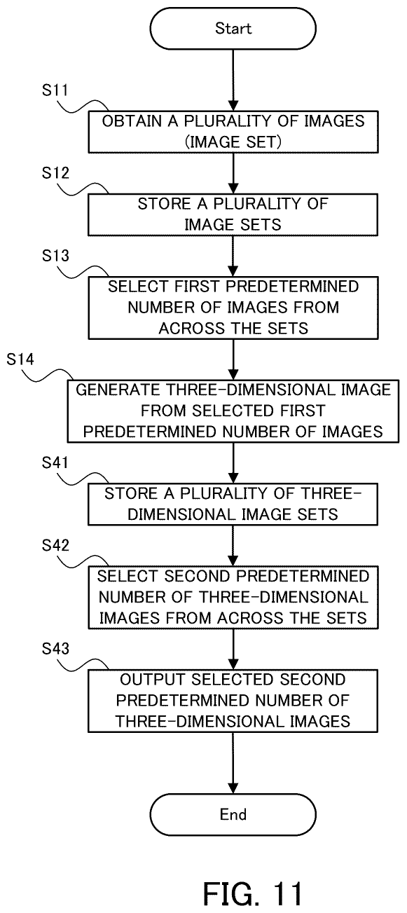

Next, with reference to FIG. 11, a flow of operation of the information processing apparatus 10 according to the fourth example embodiment will be described. FIG. 11 is a flowchart illustrating the flow of the operation of the information processing apparatus according to the fourth example embodiment. In FIG. 11, the same steps as those illustrated in FIG. 3 carry the same reference numerals.

As illustrated in FIG. 11, when the information processing apparatus 10 according to the fourth example embodiment operates, first, the image acquisition unit 110 obtains the image set including a plurality of images (step S11). Then, the first storage unit 120 stores the image set obtained by the image acquisition unit 110 (step S12).

Subsequently, the first selection unit 130 selects the first predetermined number of images from across the plurality of image sets stored in the first storage unit 120 (step S13). Then, the three-dimensional image generation unit 140 generates the three-dimensional image of the subject by using the first predetermined number of images selected by the first selection unit 130 (step S14).

Subsequently, the second storage unit 150 stores the three-dimensional image set generated by the three-dimensional image generation unit 140 (step S41). Then, the second selection unit 160 selects the second predetermined number of three-dimensional images from across the plurality of three-dimensional image sets stored in the second storage unit 150 (step S42). Then, the display unit 170 outputs, as the three-dimensional images for display, the second predetermined number of three-dimensional images selected by the second selection unit 160 (step S43). By this, the second predetermined number of three-dimensional images selected by the second selection unit 160 are displayed (presented) to the user or the like.

### (Operation of Memory)

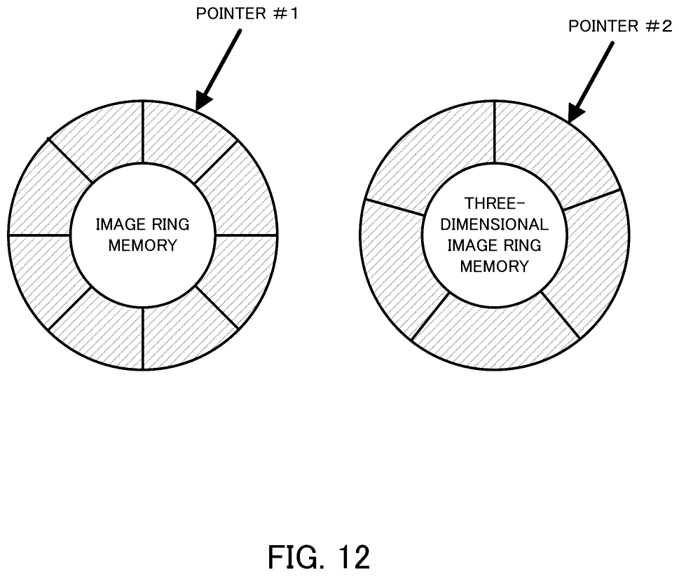

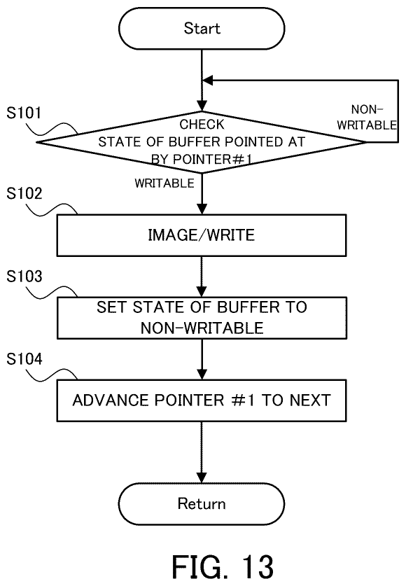

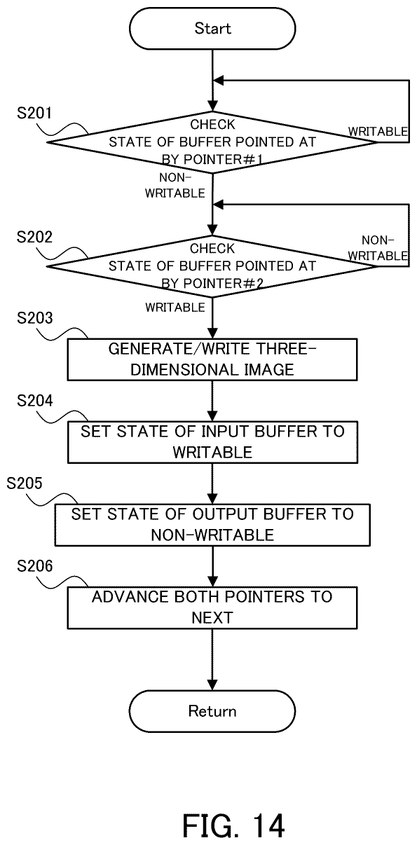

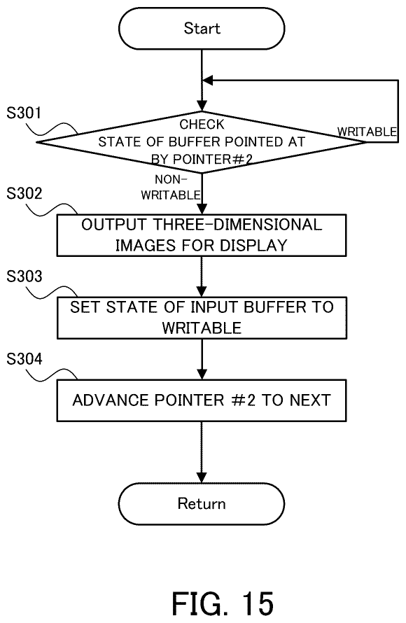

Next, with reference to FIG. 12 to FIG. 15, an operation of a memory (i.e., the first storage unit 120 and the second storage unit 150) of the information processing apparatus 10 according to the fourth example embodiment will be described. FIG. 12 is a conceptual diagram illustrating a configuration of an image ring memory and a three-dimensional image ring memory. FIG. 13 is a flowchart illustrating a flow of operation of an imaging thread in the information processing apparatus according to the fourth example embodiment. FIG. 14 is a flowchart illustrating a flow of operation of a three-dimensional image generation thread in the information processing apparatus according to the fourth example embodiment. FIG. 15 is a flowchart illustrating a flow of operation of the three-dimensional image display thread in the information processing apparatus according to the fourth example embodiment.

As illustrated in FIG. 12, the first storage unit 120 includes an image ring memory that is configured to store a plurality of images. The image ring memory includes eight buffers, each of which is configured to store an image. Each buffer has a state indicating a status. The state can be either “writable” or “non-writable”. A pointer #1 points at a buffer that is an operation target in the image ring memory.

On the other hand, the second storage unit 150 includes a three-dimensional image ring memory that is configured to store a plurality of three-dimensional images. The three-dimensional image memory includes five buffers, each of which is configured to store a three-dimensional image. Each buffer has a state indicating a status. The state can be either “writable” or “non-writable”. A pointer #2 points at a buffer that is an operation target in the three-dimensional image ring memory.

The imaging thread will be described by using the example illustrated in FIG. 13. The imaging thread is a thread corresponding to the process in which the image captured by the imaging unit 210 (see FIG. 6) or the like is obtained by the image acquisition unit 110 and is stored in the first storage unit 120.

In the imaging thread, first, the state of the buffer pointed at by the pointer #1 is checked (step S101). When the state of the buffer pointed at by the pointer #1 is “non-writable”, the subsequent process is not started. In this case, the step S101 may be performed again after a lapse of a predetermined period, for example. On the other hand, when the state of the buffer pointed at by the pointer #1 is “writable”, the captured image is obtained, and the obtained image is written in the image ring memory (step S102).

Next, the state of the buffer pointed at by the pointer #1 is set to “non-writable” (step S103). Then, the pointer #1 is advanced to a next buffer (step S104).

The three-dimensional image generation thread will be described with reference to FIG. 14. The three-dimensional image generation thread is a thread corresponding to the process in which the first selection unit 130 selects the first predetermined number of images from the plurality of image sets stored in the first storage unit 120, and in which the three-dimensional image generation unit 140 generates and stores the three-dimensional image.

In the three-dimensional image generation thread, first, the state of the buffer pointed at by the pointer #1 is checked (step S201). When the state of the buffer pointed at by the pointer #1 is “writable”, the subsequent process is not started. In this case, the step S201 may be performed again after a lapse of a predetermined period, for example.

On the other hand, when the state of the buffer pointed at by the pointer #1 is “non-writable”, the state of the buffer pointed at by the pointer #2 is checked (step S202). When the state of the buffer pointed at by the pointer #2 is “non-writable”, the subsequent process is not started. In this case, the step S202 may be performed again after a lapse of a predetermined period, for example. When the state of the buffer pointed at by the point #2 is “writable”, the three-dimensional image is generated, and the generated three-dimensional image is written in the three-dimensional image ring-memory (step S203).

Next, the state of an input buffer of the image ring memory pointed at by the pointer #1 is set to “writable” (step S204). In addition, the state of an output buffer of the three-dimensional image ring memory pointed at by the pointer #2 is set to “non-writable” (step S205). Then, each of the pointer #1 and the pointer #2 is advanced to a next buffer (step S206).

The three-dimensional image display thread will be described with reference to FIG. 15. Three-dimensional image display thread is a thread corresponding to the process in which the second selection unit 160 selects the second predetermined number of three-dimensional images from the plurality of three-dimensional image sets stored in the second storage unit 150, and in which the display unit 170 outputs them as the three-dimensional images for display.

In the three-dimensional image generation thread first checks state of the buffer pointed at by the pointer #2 (step S301). When the state of the buffer pointed at by the pointer #2 is “writable”, the subsequent process is not started. In this case, the step S301 may be performed after a lapse of a predetermined period, for example. On the other hand, when the state of the buffer pointed at by the pointer #1 is “non-writable”, the selected three-dimensional images are outputted as the three-dimensional images for display (step S302).

Then, the state of the buffer pointed at by the pointer #2 is set to “writable” (step S303). Then, the pointer #2 is advanced to a next buffer (step S304).

### (Technical Effect)

Next, a technical effect obtained by the information processing apparatus 10 according to the fourth example embodiment will be described.

As described in FIG. 10 to FIG. 15, in the information processing apparatus 10 according to the fourth example embodiment, the second predetermined number of three-dimensional images are selected from across the plurality of three-dimensional image sets. In this way, it is possible to display the second predetermined number of images included in the different three-dimensional image sets. In this case, the three-dimensional images can be displayed more properly than when only the three-dimensional images included in a single image set are displayed. For example, it is possible to select and display the three-dimensional images that are suitable for display (in other words, by excluding three-dimensional images that are not suitable for display).

### Modified Example of Fourth Example Embodiment

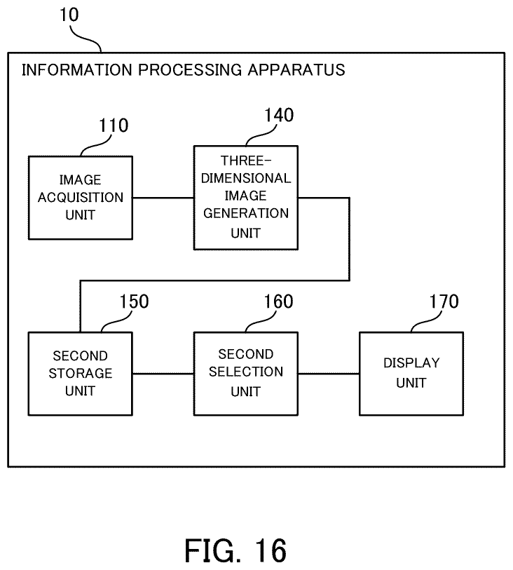

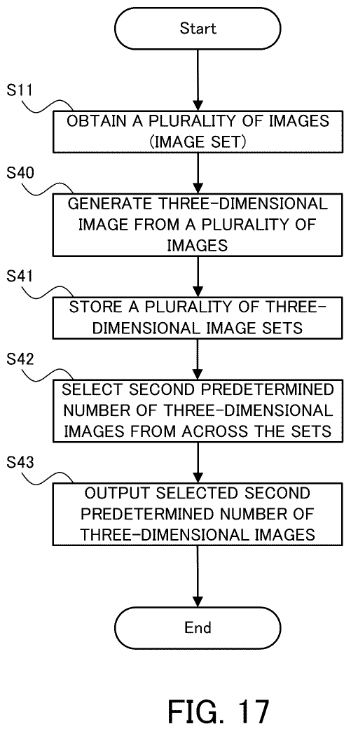

Next, the information processing apparatus 10 according to a modified example of the fourth example embodiment will be described with reference to FIG. 16 and FIG. 17. The modified example of the fourth example embodiment is partially different from the fourth example embodiment, and are generally the same as the fourth example embodiment in the other parts. For this reason, a part that is different from the fourth example embodiment will be described in detail below, and a description of the other overlapping parts will be omitted as appropriate.

### (Functional Configuration)

First, with reference to FIG. 16, a functional configuration of the information processing apparatus 10 according to the modified example of the fourth example embodiment will be described. FIG. 16 is a block diagram illustrating the functional configuration of the information processing apparatus according to the modified example of the fourth example embodiment. In FIG. 16, the same components as those illustrated in FIG. 10 carry the same reference numerals.

As illustrated in FIG. 16, the information processing apparatus 10 according to the modified example of the fourth example embodiment includes, as processing blocks for realizing the functions thereof, the image acquisition unit 110, the three-dimensional image generation unit 140, the second storage unit 150, the second selection unit 160, and the display unit 170. That is, the information processing apparatus 10 according to the modified example of the fourth example embodiment does not include the first storage unit 120 and the first selection unit 130, when compared with the configuration according to the second example embodiment (see FIG. 10).

### (Flow of Operation)

Next, a flow of operation of the information processing apparatus 10 according to the modified example of the fourth example embodiment will be described with reference to FIG. 17. FIG. 17 is a flowchart illustrating the flow of the operation of the information processing method according to the modified example of the fourth example embodiment. In FIG. 17, the same steps as those illustrated in FIG. 11 carry the same reference numerals.

As illustrated in FIG. 17, in the information processing apparatus 10 according to the modified example of the fourth example embodiment, first, the image acquisition unit 110 obtains the image set including a plurality of images (step S11). Then, the three-dimensional image generation unit 140 generates the three-dimensional image of the subject by using the image set obtained by the image acquisition unit 110 (step S40). That is, the three-dimensional image is directly generated without performing the storage by the first storage unit 120 and the selection by the first selection unit 130, unlike the fourth example embodiment.

Subsequently, the second storage unit 150 stores the three-dimensional image set generated by the three-dimensional image generation unit 140 (step S41). Then, the second selection unit 160 selects the second predetermined number of three-dimensional images from across the plurality of three-dimensional image sets stored in the second storage unit 150 (step S42). Then, the display unit 170 outputs, as the three-dimensional images for display, the second predetermined number of three-dimensional images selected by the second selection unit 160 (step S43).

### (Technical Effect)

Next, a technical effect obtained by the information processing apparatus 10 according to the modified example of the fourth example embodiment will be described.

As described in FIG. 16 and FIG. 17, in the information processing apparatus 10 according to the modified example of the fourth example embodiment, the second predetermined number of three-dimensional images are selected from across the plurality of three-dimensional image sets, as in the fourth example embodiment. In this way, it is possible to display the second predetermined number of images included in the different three-dimensional image sets.

### Fifth Example Embodiment

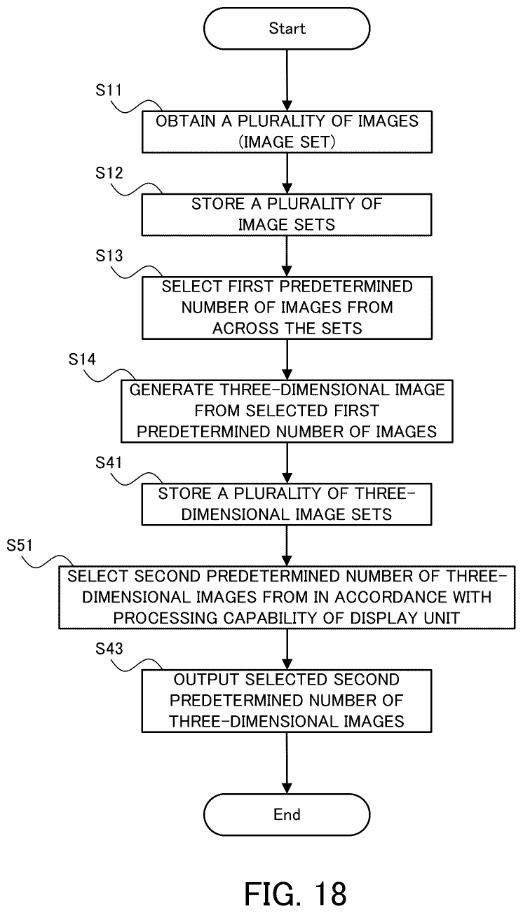

With reference to FIG. 18, the information processing apparatus 10 according to a fifth example embodiment will be described. The fifth example embodiment is partially different from the fourth example embodiment only in the operation, and may be the same as the fourth example embodiment in other parts. For this reason, a part that is different from each of the example embodiments described above will be described in detail below, and a description of the other overlapping parts will be omitted as appropriate.

### (Flow of Operation)

First, with reference to FIG. 18, a flow of operation of the information processing apparatus 10 according to the fifth example embodiment will be described. FIG. 18 is a flowchart illustrating the flow of the operation of the information processing apparatus according to the fifth example embodiment. In FIG. 18, the same steps as those illustrated in FIG. 11 carry the same reference numerals.

As illustrated in FIG. 18, in operation of the information processing apparatus 10 according to the fifth example embodiment, first, the image acquisition unit 110 obtains the image set including a plurality of images (step S11). Then, the first storage unit 120 stores the image set obtained by the image acquisition unit 110 (step S12).

Subsequently, the first selection unit 130 selects the first predetermined number of images from across the plurality of image sets stored in the first storage unit 120 (step S13). Then, the three-dimensional image generation unit 140 generates the three-dimensional image of the subject by using the first predetermined number of images selected by the first selection unit 130 (step S14).

Subsequently, the second storage unit 150 stores the three-dimensional image set generated by the three-dimensional image generation unit 140 (step S41). Then, the second selection unit 160 selects the second predetermined number of three-dimensional images from across the plurality of three-dimensional image sets stored in the second storage unit 150. In this case, especially in the fifth example embodiment, the second selection unit 160 selects the second predetermined number of images in accordance with a processing capacity of the display unit 170 (step S51). That is, the second selection unit 160 selects the images in accordance with the subsequent processing capability. Then, the display unit 170 outputs, as the three-dimensional images for display, the second predetermined number of three-dimensional images selected by the second selection unit 160 (step S43).

The “processing capability of the display unit 170” described above may be a processing capability in specifications of the display unit 170, or may be a processing capability at that time point that takes into account a computational load of the process that is being executed. The second selection unit 160 changes the number of three-dimensional images to be selected (i.e., a value of the second predetermined number) in accordance with the processing capacity of the display unit 170, for example. In this case, the number of the three-dimensional images outputted by the display unit 170 varies in accordance with the processing capacity. Alternatively, the second selection unit 160 changes a frequency of selecting the three-dimensional images in accordance with the processing capability of the display unit 170. In this case, the frequency of outputting the three-dimensional images to the display unit 170 varies, and consequently, the number of three-dimensional images processed per unit time by the display unit 170 varies.

### (Technical Effect)

Next, a technical effect obtained by the information processing apparatus 10 according to the fifth example embodiment will be described.

As described in FIG. 18, in the information processing apparatus 10 according to the fifth example embodiment, the second predetermined number of images are selected in accordance with the processing capacity of the display unit 170. In this way, it is possible to properly output the three-dimensional images in view of the processing capability of the display unit 170. For example, when the processing capacity of the display unit 170 is dropping, the second selection unit 160 reduces the number of images to be selected. In this case, since the number of three-dimensional images processed at one time by the display unit 170 is reduced, even the display unit 170 with a reduced processing capacity is capable of successfully performing the process of outputting the three-dimensional images. Alternatively, when the processing capacity of the display unit 170 is dropping, the second selection unit 160 selects the three-dimensional images less frequently. In this case, since the number of three-dimensional images processed per unit time by the display unit 170 is reduced, even the display unit 170 with a reduced processing capacity is capable of performing the process of outputting the three-dimensional images without a problem. The configuration that takes into account the processing capability of the display unit 170 in the fifth example embodiment may be combined with the configuration that takes into account the processing capability of the three-dimensional image generation unit 140 described in the second example embodiment (see FIG. 5). In this case, since the processing capabilities of the display unit 170 and the three-dimensional image generation unit 140 are respectively considered, it is possible to realize a more efficient process than the process when only one of the processing capabilities is considered.

### Sixth Example Embodiment

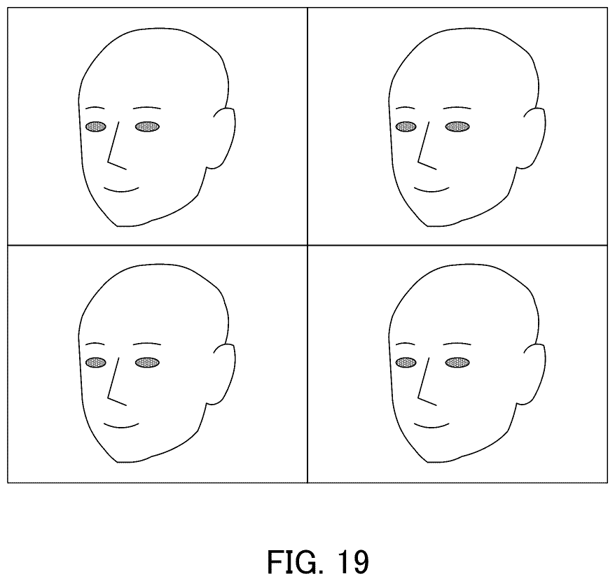

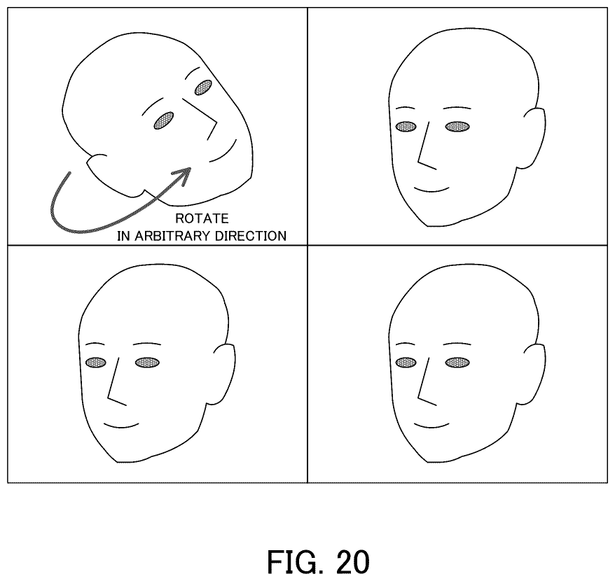

The information processing apparatus 10 according to a sixth example embodiment will be described with reference to FIG. 19 and FIG. 20. The sixth example embodiment describes a specific example of a display aspect of the display unit 170 in the fourth and fifth example embodiments, and may be the same as those of the fourth and fifth example embodiments in the other operation and apparatus configuration. For this reason, a part that is different from each of the example embodiments described above will be described in detail below, and a description of the other overlapping parts will be omitted as appropriate.

### (List of Three-Dimensional Image)

First, with reference to FIG. 19, the display aspect realized by the information processing apparatus 10 according to the sixth example embodiment will be described. FIG. 19 is a diagram illustrating an example of a list of three-dimensional images by the information processing apparatus according to the sixth example embodiment. In the following description, the subject 50 is assumed to be a face of a person.

As illustrated in FIG. 19, the information processing apparatus 10 according to the sixth example embodiment is configured to output a plurality of three-dimensional images in a display aspect of listing them. Specifically, the display unit 170 displays each of the second predetermined number of three-dimensional images selected by the second selection unit 160, in a format of listing them. Consequently, the three-dimensional images are listed on a display apparatus with a display or the like.

In the example illustrated in FIG. 19, four three-dimensional images are displayed in four areas that are upper right, lower right, upper left, and lower left areas, but may be listed in a different display aspect. Specifically, a plurality of three-dimensional images may be listed in such a display aspect that they are aligned horizontally. Alternatively, a plurality of three-dimensional images may be listed in such a display aspect that they are aligned vertically. The listed plurality of three-dimensional images are preferably displayed to entirely fit within a screen, but a part of them may be out of the screen. For example, the three-dimensional images that are out of the screen, may be displayed within the screen by a scrolling operation or a swiping operation, for example.

In the example illustrated in FIG. 19, the plurality of three-dimensional images are displayed in the same size. The plurality of three-dimensional images, however, may be displayed in different sizes from each other. For example, one image may be displayed large, and the other images may be displayed small. Alternatively, one image may be displayed small, and the other images may be displayed large. In addition, a plurality of three-dimensional images may be displayed in a unique size that is different from the other three-dimensional images. For example, there may be a three-dimensional image that is displayed the largest, a three-dimensional image that is displayed the second largest, a three-dimensional image that is displayed the third largest, and a three-dimensional image that is displayed the fourth largest.

### (Rotation of Three-Dimensional Image)

Next, with reference to FIG. 20, another display aspect realized by the information processing apparatus 10 according to the sixth example embodiment will be described. FIG. 20 is a diagram illustrating an example of the display aspect in the information processing apparatus according to the sixth example embodiment.

As illustrated in FIG. 20, the information processing apparatus 10 according to the sixth example embodiment may display a plurality of three-dimensional images to rotate. In the example illustrated in FIG. 20, only the upper left three-dimensional image is displayed to rotate, but the other three-dimensional images may also be displayed to rotate. For example, all of the displayed three-dimensional images may be displayed to rotate, or a part of the plurality of three-dimensional images may be displayed to rotate. Which three-dimensional image is to rotate, may be set in advance by the user or the like, or may be automatically determined in accordance with various parameters of the three-dimensional image.

When a plurality of three-dimensional images are displayed to rotate, their rotating directions may be the same or may be different. Their rotational speeds may be the same or may be different. The rotating direction and the rotational speed of each of the three-dimensional images may be changed automatically in the middle. That is, a three-dimensional image that rotates clockwise, may start to rotate counterclockwise from the middle. In addition, a three-dimensional image that rotates relatively slowly, may rotate relatively quickly from the middle. The rotating direction and the rotational speed may be set in advance by the user or the like, or may be automatically determined in accordance with various parameters of the three-dimensional image.

The information processing apparatus 10 according to the sixth example embodiment may perform a display to emphasize a difference of the plurality of three-dimensional images, in addition to or in place of the rotation and display. Specifically, the plurality of three-dimensional images to be displayed may be compared to highlight a part with a large difference. An example of the highlighting includes displaying in different colors, shading, enclosing with a frame, and the like. In a more specific example, for example, when one three-dimensional image is an image of a blinking face (i.e., in which eyes are closed) and another three-dimensional image is an image of an unblinking face (i.e., in which eyes are open), a part around the eyes in at least one of the three-dimensional images may be highlighted.

### (Technical Effect)

Next, a technical effect obtained by the information processing apparatus 10 according to the sixth example embodiment will be described.

As described in FIG. 19 and FIG. 20, in the information processing apparatus 10 according to the sixth example embodiment, a plurality of three-dimensional images are listed. In this way, it is possible to present the three-dimensional images to the user more than when only a single three-dimensional image is displayed. Furthermore, by comparing a plurality of three-dimensional image side by side, it is possible to easily determine the difference between them.

### Seventh Example Embodiment

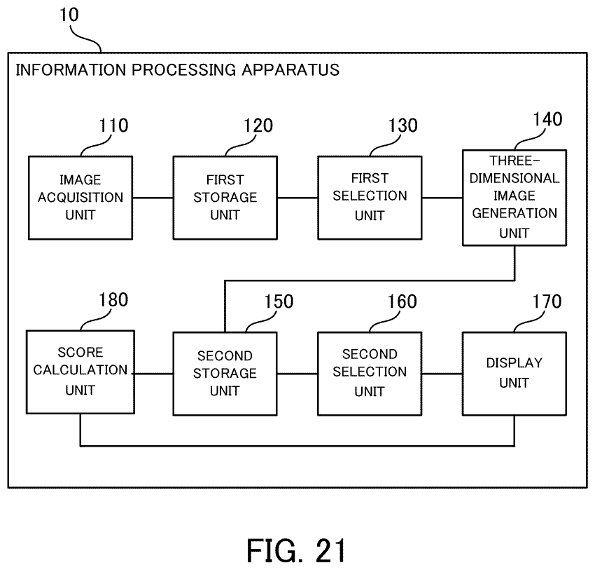

The information processing apparatus 10 according to a seventh example embodiment will be described with reference to FIG. 21 to FIG. 23. The seventh example embodiment is partially different from the fourth to sixth example embodiments only in the configuration and operation, and may be the same as the fourth to sixth example embodiments in the other parts. For this reason, a part that is different from each of the example embodiments described above will be described in detail below, and a description of the other overlapping parts will be omitted as appropriate.

### (Functional Configuration)

First, with reference to FIG. 21, afunctional configuration of the information processing apparatus 10 according to the seventh example embodiment will be described. FIG. 21 is a block diagram illustrating the functional configuration of the information processing apparatus according to the seventh example embodiment. In FIG. 21, the same components as those illustrated in FIG. 10 carry the same reference numerals.

As illustrated in FIG. 21, the information processing apparatus 10 according to the seventh example embodiment includes, as processing blocks for realizing the functions thereof, the image acquisition unit 110, the first storage unit 120, the first selection unit 130, the three-dimensional image generation unit 140, the second storage unit 150, the second selection unit 160, the display unit 170, and a score calculation unit 180. That is, the information processing apparatus 10 according to the seventh example embodiment further includes the score calculation unit 180 in addition to the configuration (see FIG. 10) in the fourth example embodiment. The score calculation unit 180 may be realized or implemented by the processor 11 (see FIG. 1).

The score calculation unit 180 is configured to calculate a score of each of the three-dimensional images generated by the three-dimensional image generation unit 140. The “score” here is a score indicating the quality of the three-dimensional image, and is calculated as a larger value as the quality of the three-dimensional image is higher, for example. More specifically, the score is calculated in accordance with various conditions, such as whether the three-dimensional image is blurred, and whether a target in the three-dimensional image is in a good condition (e.g., whether a person does not close the eyes). The above is merely an example, and the score may be calculated by using another criterion. Furthermore, when the score is calculated by using a plurality of conditions, for example, the score may be calculated one by one from each condition, and then, an average value of the scores may be calculated to make a final score. Information about the score calculated by the score calculation unit 180 is configured to be outputted to the display unit 170. The display unit 170 changes the display aspect of the three-dimensional image in accordance with the score as described later.

### (Flow of Operation)

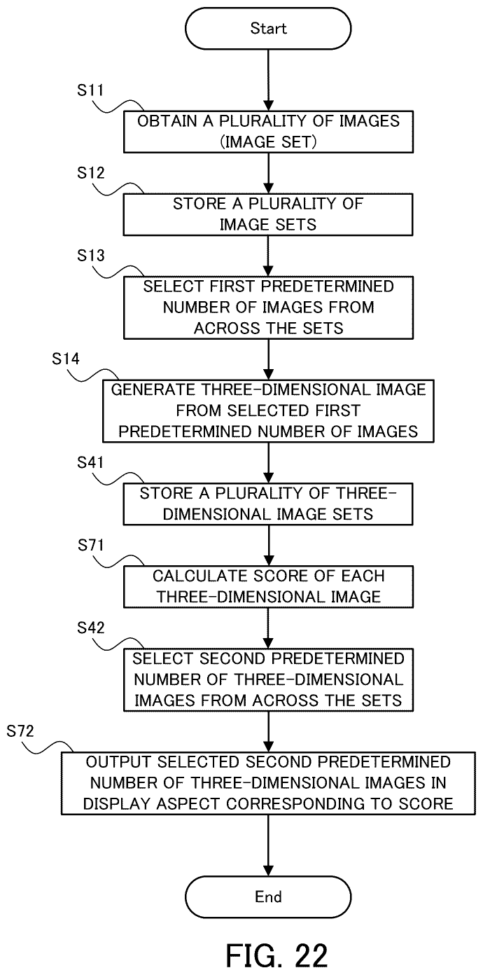

Next, with reference to FIG. 22, a flow of operation of the information processing apparatus 10 according to the seventh example embodiment will be described. FIG. 22 is a flowchart illustrating the flow of the operation of the information processing apparatus according to the seventh example embodiment. In FIG. 22, the same steps as those illustrated in FIG. 11 carry the same reference numerals.

As illustrated in FIG. 22, in operation of the information processing apparatus 10 according to the seventh example embodiment, first, the image acquisition unit 110 obtains the image set including a plurality of images (step S11). Then, the first storage unit 120 stores the image set obtained by the image acquisition unit 110 (step S12).

Subsequently, the first selection unit 130 selects the first predetermined number of images from across the plurality of image sets stored in the first storage unit 120 (step S13). Then, the three-dimensional image generation unit 140 generates the three-dimensional image of the subject by using the first predetermined number of images selected by the first selection unit 130 (step S14). Subsequently, the second storage unit 150 stores the three-dimensional image set generated by the three-dimensional image generation unit 140 (step S41).

Especially in the seventh example embodiment, the score calculation unit 180 calculates the score of the three-dimensional image (step S71). The score calculation unit 180 outputs the calculated score to the display unit 170. The score may be calculated at a time at which the three-dimensional image is generated. Alternatively, the score may be calculated at a time immediately before the three-dimensional image is outputted from the display unit 170.

Then, the second selection unit 160 selects the second predetermined number of three-dimensional images from across the plurality of three-dimensional image sets stored in the second storage unit 150 (step S42). Then, the display unit 170 outputs the second predetermined number of three-dimensional images selected by the second selection unit 160, as the three-dimensional images for display. Especially in the seventh example embodiment, the three-dimensional images are outputted to be displayed in a display aspect corresponding to the score calculated by the score calculation unit 180 (step S72). The display aspect corresponding to the score will be described below with a specific example.

### Display Example

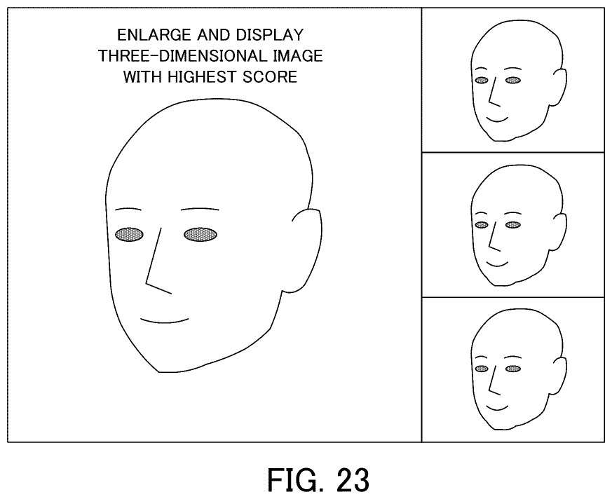

Next, with reference to FIG. 23, the display aspect realized by the information processing apparatus 10 according to the seventh example embodiment will be specifically described. FIG. 23 is a diagram illustrating an example of the display aspect in the information processing apparatus according to the seventh example embodiment.

As illustrated in FIG. 23, the information processing apparatus 10 according to the seventh example embodiment may enlarge and display a three-dimensional image with the highest score. In other words, the three-dimensional image with the highest score may be displayed large, while the other three-dimensional images may be displayed small. In the example in FIG. 23, only the three-dimensional image with the highest score is enlarged, but a plurality of three-dimensional images with high scores may be enlarged. For example, three three-dimensional images may be selected in descending order of the score, and the selected three three-dimensional images may be enlarged. Furthermore, an enlargement ratio may be changed in accordance with the score. For example, the three-dimensional image with the highest score may be displayed the largest, a three-dimensional image with the second highest score may be displayed the second largest, a three-dimensional image with the third highest score may be displayed the third largest, and a three-dimensional image with the fourth highest score may be displayed the fourth largest. Contrary to the above example, a three-dimensional image with a low score may be enlarged and displayed.

When the display aspect is changed in accordance with the score, a value of the score of each three-dimensional image may be superimposed on the three-dimensional image and may be then displayed. The value of the score may be displayed for all the three-dimensional images, or may be displayed only for the three-dimensional image with the highest score or a plurality of three-dimensional images with high scores. The score may be displayed in a numerical value, or may be displayed in a graph or the like.

The aspect of enlarging and displaying the three-dimensional image described above is merely an example, and various display aspects may be realized by using the calculated score of each image.

The information processing apparatus 10 according to the seventh example embodiment may highlight only a three-dimensional image with a high score, for example. For example, the three-dimensional image with the highest score or three-dimensional images with high scores may be displayed in different color, shaded, or enclosed with a frame. In highlighting, only the three-dimensional image with the highest score may be highlighted, or a plurality of three-dimensional images with high scores may be highlighted.

The information processing apparatus 10 according to the seventh example embodiment may display only three-dimensional images with high scores. For example, it may display only a three-dimensional image with a score that is greater than or equal to a predetermined threshold, and may not display a three-dimensional image with a score that is less than the predetermined threshold. In this case, the predetermined threshold may be set by the user as appropriate. In addition, only a predetermined number of three-dimensional images may be displayed, and the other three-dimensional images may not be displayed. In this case, the predetermined number may be set by the user as appropriate.

The information processing apparatus 10 according to the seventh example embodiment may rearrange and display the three-dimensional images in the order of the score. For example, the three-dimensional images may be displayed in descending order of the score. In this case, the three-dimensional images with low scores may not be displayed. That is, only the three-dimensional images with respectively high scores may be displayed side by side in the order of the score. Alternatively, the three-dimensional images may be rearranged and displayed in ascending order of the score. In this case, the three-dimensional images with high scores may not be displayed. That is, only the three-dimensional image with respectively low scores may be displayed in the order of the score.

The information processing apparatus 10 according to the seventh example embodiment may rotate and display only the three-dimensional image with a higher score (see the sixth example embodiment for the rotation and display). For example, the three-dimensional image with the highest score may be rotated, or a plurality of three-dimensional images with high scores may be rotated. The rotating direction and the rotational speed of the three-dimensional image may be changed in accordance with the score. For example, the image with a high score may rotate quickly, while the three-dimensional image with a low score may rotate slowly.

### (Technical Effect)

Next, a technical effect obtained by the information processing apparatus 10 according to the seventh example embodiment will be described.

As described in FIG. 21 to FIG. 23, in the information processing apparatus 10 according to the seventh example embodiment, the display aspect of the three-dimensional image is changed in accordance with the calculated score. In this way, it is possible to present the three-dimensional image to the user in a more appropriate aspect in accordance with the score (in other words, quality) of the three-dimensional image.

### Eighth Example Embodiment

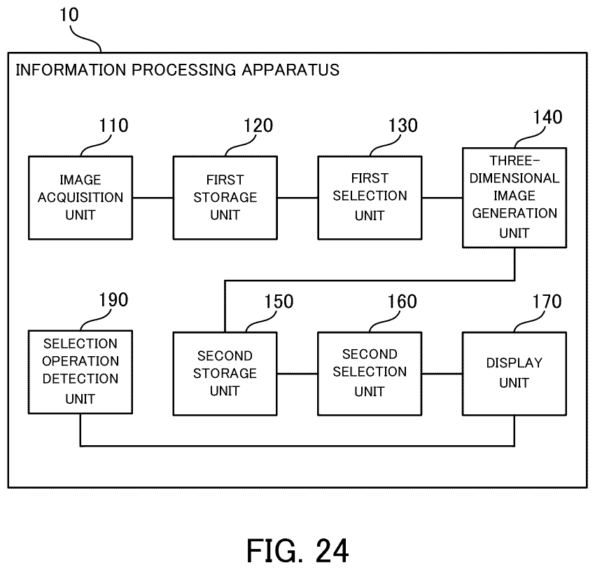

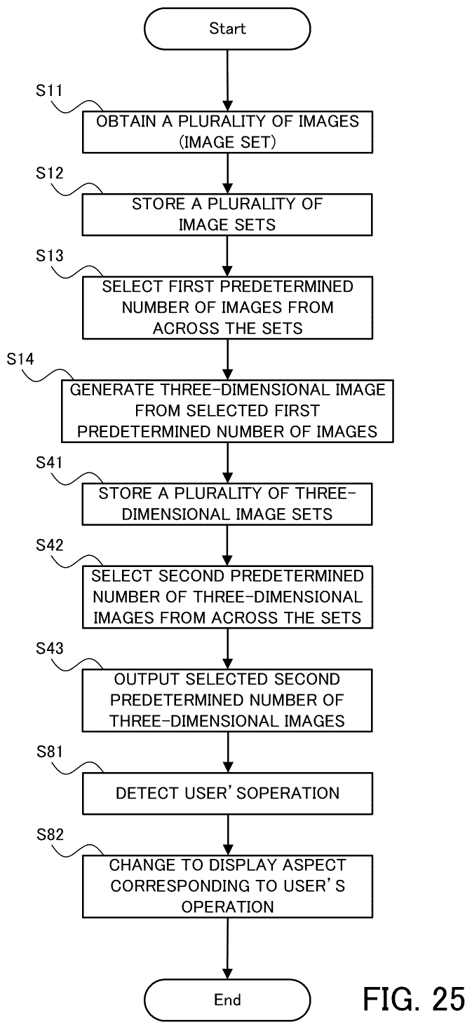

The information processing apparatus 10 according to an eighth example embodiment will be described with reference to FIG. 24 and FIG. 25. The eighth example embodiment is partially different from the fourth to seventh example embodiments only in the configuration and operation, and may be the same as the fourth to seventh example embodiments in the other parts.

For this reason, a part that is different from each of the example embodiments described above will be described in detail below, and a description of the other overlapping parts will be omitted as appropriate.

### (Functional Configuration)

First, with reference to FIG. 24, a functional configuration of the information processing apparatus 10 according to the eighth example embodiment will be described. FIG. 24 is a block diagram illustrating the functional configuration of the information processing apparatus according to the eighth example embodiment. In FIG. 24, the same components as those illustrated in FIG. 10 carry the same reference numerals.

As illustrated in FIG. 24, the information processing apparatus 10 according to the eighth example embodiment includes, as processing blocks for realizing the functions thereof, the image acquisition unit 110, the first storage unit 120, the first selection unit 130, the three-dimensional image generation unit 140, the second storage unit 150, the second selection unit 160, the display unit 170, and a selection operation detection unit 190. That is, the information processing apparatus 10 according to the eighth example embodiment further includes the selection operation detection unit 190 in addition to the configuration (see FIG. 10) in the fourth example embodiment. The selection operation detection unit 190 may be realized or implemented by the processor 11 (see FIG. 1).

The selection operation detection unit 190 is configured to detect an operation of selecting the three-dimensional image by the user. The selection operation detection unit 190 is configured to detect the user's operation performed by the input apparatus 15 (see FIG. 1), for example. The selection operation detection unit 190 may detect an operation of selecting a single three-dimensional image from a plurality of three-dimensional images displayed. The selection operation detection unit 190 may detect an operation of selecting two or more three-dimensional images from the plurality of three-dimensional images displayed. When the selection operation is detected, the selection operation detection unit 190 outputs information that specifies the selected three-dimensional image, to the display unit 170. The display unit 170 changes the display aspect of the three-dimensional image in accordance with the selection operation as described later.

### (Flow of Operation)

Next, a flow of operation of the information processing apparatus 10 according to the eighth example embodiment will be described with reference to FIG. 25. FIG. 25 is a flowchart illustrating the flow of the operation of the information processing apparatus according to the eighth example embodiment. In FIG. 25, the same steps as those illustrated in FIG. 11 carry the same reference numerals.

As illustrated in FIG. 25, in operation of the information processing apparatus 10 according to the eighth example embodiment operates, first, the image acquisition unit 110 obtains the image set including a plurality of images (step S11). Then, the first storage unit 120 stores the image set obtained by the image acquisition unit 110 (step S12).

Subsequently, the first selection unit 130 selects the first predetermined number of images from across the plurality of image sets stored in the first storage unit 120 (step S13). Then, the three-dimensional image generation unit 140 generates the three-dimensional image of the subject by using the first predetermined number of images selected by the first selection unit 130 (step S14).

Subsequently, the second storage unit 150 stores the three-dimensional image set generated by the three-dimensional image generation unit 140 (step S41). Then, the second selection unit 160 selects the second predetermined number of three-dimensional images from across the plurality of three-dimensional image sets stored in the second storage unit 150 (step S42). Then, the display unit 170 outputs, as the three-dimensional images for display, the second predetermined number of three-dimensional images selected by the second selection unit 160 (step S43).

Then, especially in the eighth example embodiment, the selection operation detection unit 190 detects the selection operation by the user (step S81). Then, the display aspect of the three-dimensional image is changed in accordance with the detected selection operation (step S82).

### Display Example

In the information processing apparatus 10 according to the eighth example embodiment, the display aspect may be changed as appropriate in accordance with the three-dimensional image selected by the user's operation. The display aspect in this case may be the same as that exemplified in the seventh example embodiment.

The information processing apparatus 10 according to the eighth example embodiment may enlarge and display the three-dimensional image selected by the user, for example. Alternatively, the three-dimensional image selected by the user may be highlighted. Alternatively, only the three-dimensional image selected by the user may be displayed. Alternatively, the three-dimensional image selected by the user may be displayed to rotate.

In addition, the information processing apparatus 10 according to the eighth example embodiment may display a slide show by using the three-dimensional images selected by the user. In this case, the three-dimensional images may be displayed in the order of the user's selection. Alternatively, a plurality of two-dimensional images may be displayed for the three-dimensional image selected by the user. For example, if the three-dimensional image is an image of a person's face, a two-dimensional image of the face viewed from the right side, a two-dimensional image of the face viewed from the left side, a two-dimensional image of the face viewed from the top, and the like, may be displayed on the basis of the selected three-dimensional image.

The above-described display example is merely an example, and various display aspects corresponding to the selection operation by the user may be employed. For example, the three-dimensional image may be displayed three-dimensionally by using AR (Augmented Reality), holographic techniques/technologies, or the like.

### (Technical Effect)

Next, a technical effect obtained by the information processing apparatus 10 according to the eighth example embodiment will be described.

As described in FIG. 24 and FIG. 25, in the information processing apparatus 10 according to the eighth example embodiment, the display aspect of the three-dimensional image is changed in accordance with the selection operation by the user. In this way, it is possible to present the three-dimensional image in a more appropriate aspect in response to the user's operation (in other words, reflecting the user's intention).

### Specific Application Example

A specific application example of the information processing apparatus of the first to eighth example embodiments will be described.

### (Three-Dimensional Facial Shape Measurement Apparatus)

Each of the above-described example embodiments is applicable to a three-dimensional facial shape measurement apparatus that measures a three-dimensional shape of a face. The three-dimensional facial shape measurement apparatus is configured to measure the three-dimensional shape of the face of a person who is a subject, by imaging the face of the person with two right and left cameras and synthesizing captured images. More specifically, the right camera captures an image of the right side of the face, and the left camera captures an image of the left side of the face. Then, a shape of the right side of the face created from the image of the right side of the face and a shape of the left side of the face created from the image of the left side of the face are synthesized to create a three-dimensional shape of the entire face of the person (e.g., including ears). The three-dimensional facial shape measurement apparatus may be an apparatus that captures an image while applying a sinusoidal pattern to the subject, and that performs a measurement using a sinusoidal grating shift method, for example.

A processing method in which a program for allowing the configuration in each of the example embodiments to operate to realize the functions of each example embodiment is recorded on a recording medium, and in which the program recorded on the recording medium is read as a code and executed on a computer, is also included in the scope of each of the example embodiments. That is, a computer-readable recording medium is also included in the range of each of the example embodiments. Not only the recording medium on which the above-described program is recorded, but also the program itself is also included in each example embodiment.

The recording medium may be, for example, a floppy disk (registered trademark), a hard disk, an optical disk, a magneto-optical disk, a CD-ROM, a magnetic tape, a nonvolatile memory card, or a ROM. Furthermore, not only the program that is recorded on the recording medium and executes processing alone, but also the program that operates on an OS and executes processing in cooperation with the functions of expansion boards and another software, is also included in the scope of each of the example embodiments.

This disclosure is not limited to the examples described above and is allowed to be changed, if desired, without departing from the essence or spirit of this disclosure which can be read from the claims and the entire specification. An information processing apparatus, an information processing method, a computer program, and a recording medium with such changes are also intended to be within the technical scope of this disclosure.

### <Supplementary Notes>

The example embodiments described above may be further described as, but not limited to, the following Supplementary Notes below.

### (Supplementary Note 1)

An information processing apparatus described in Supplementary Note 1 is an information processing apparatus including: an acquisition unit that obtains an image set including a plurality of images in which a subject is captured; a first storage unit that stores a plurality of image sets; a first selection unit that selects a first predetermined number of images from across the plurality of image sets; and a generation unit that generates a three-dimensional image of the subject on the basis of the first predetermined number of images.

### (Supplementary Note 2)

An information processing apparatus described in Supplementary Note 2 is the information processing apparatus described in Supplementary Note 1, wherein the first selection unit selects the first predetermined number of images in accordance with a processing capability of the generation unit.

### (Supplementary Note 3)

An information processing apparatus described in Supplementary Note 3 is the information processing apparatus described in Supplementary Note 1 or 2, wherein the plurality of images include: an image captured with a sinusoidal pattern in a sinusoidal grating shape projected on the subject; an image captured with a luminance gradient pattern, in which a luminance value changes linearly, projected on the subject; and a texture image indicating a state of a surface of the subject.

### (Supplementary Note 4)

An information processing apparatus described in Supplementary Note 4 is the information processing apparatus described in any one of Supplementary Notes 1 to 3, further including: a second storage unit that stores a plurality of three-dimensional image sets including a plurality of three-dimensional images; a second selection unit that selects a second predetermined number of three-dimensional images from across the plurality of three-dimensional image sets; and a display unit that displays the second predetermined number of three-dimensional images.

### (Supplementary Note 5)

An information processing apparatus described in Supplementary Note 5 is the information processing apparatus described in Supplementary Note 4, wherein the second selection unit selects the second predetermined number of three-dimensional images in accordance with a processing capability of the display unit.

### (Supplementary Note 6)

An information processing apparatus described in Supplementary Note 6 is the information processing apparatus described in Supplementary Note 4 or 5, wherein the display unit displays a list of the second predetermined number of three-dimensional images.

### (Supplementary Note 7)

An information processing apparatus described in Supplementary Note 7 is the information processing apparatus described in any one of Supplementary Notes 4 to 6, further including a calculation unit that calculates a score corresponding to a predetermined evaluation criterion for each of the second predetermined number of three-dimensional images, wherein the display unit changes a display aspect of each of the second predetermined number of three-dimensional images in accordance with the score.

### (Supplementary Note 8)

An information processing apparatus described in Supplementary Note 8 is the information processing apparatus described in any one of Supplementary Notes 4 to 7, further including a detection unit that detects a selection operation of selecting a part of the second predetermined number of the three-dimensional images, wherein the display unit changes a display aspect of the three-dimensional image selected by the selection operation.

### (Supplementary Note 9)

An information processing method described in Supplementary Note 9 is an information processing method including: obtaining an image set including a plurality of images in which a subject is captured; storing a plurality of image sets; selecting a first predetermined number of images from across the plurality of image sets; and generating a three-dimensional image of the subject on the basis of the first predetermined number of images.

### (Supplementary Note 10)

A computer program described in Supplementary Note 10 is a computer program that operates a computer: to obtain an image set including a plurality of images in which a subject is captured; to store a plurality of image sets; to select a first predetermined number of images from across the plurality of image sets; and to generate a three-dimensional image of the subject on the basis of the first predetermined number of images.

### (Supplementary Note 11)

A recording medium described in Supplementary Note 11 is a recording medium on which the computer program described in Supplementary Note 10 is recorded.

To the extent permitted by law, this application claims priority to Japanese Patent application No. 2020-198259, filed on Nov. 30, 2020, the entire disclosure of which is hereby incorporated by reference. Furthermore, to the extent permitted by law, all publications and papers described herein are incorporated herein by reference.

### DESCRIPTION OF REFERENCE CODES

10 Information processing apparatus
11 Processor
50 Subject
110 Image acquisition unit
120 First storage unit
130 First selection unit
140 Three-dimensional image generation unit
150 Second storage unit
160 Second selection unit
170 Display unit
180 Score calculation unit
190 Selection operation detection unit
210 Imaging unit
220 Projection unit

What is claimed is:

1. An information processing apparatus comprising:
at least one memory that is configured to store instructions; and
at least one first processor that is configured to execute the instructions to
obtain an image set including a plurality of images in which a subject is captured;
store a plurality of image sets;
select a first predetermined number of images from across the plurality of image sets; and
generate a three-dimensional image of the subject on the basis of the first predetermined number of images.

2. The information processing apparatus according to claim 1, wherein the at least one first processor is configured to execute the instructions to select the first predetermined number of images in accordance with a processing capability of the generation unit.

3. The information processing apparatus according to claim 1, wherein the plurality of images include: an image captured with a sinusoidal pattern in a sinusoidal grating shape projected on the subject; an image captured with a luminance gradient pattern, in which a luminance value changes linearly, projected on the subject; and a texture image indicating a state of a surface of the subject.

4. The information processing apparatus according to claim 1, further comprising a second processor that is configured to execute the instructions to:
store a plurality of three-dimensional image sets including a plurality of three-dimensional images;
select a second predetermined number of three-dimensional images from across the plurality of three-dimensional image sets; and
display the second predetermined number of three-dimensional images.

5. The information processing apparatus according to claim 4, wherein the second processor is configured to execute the instructions to select the second predetermined number of three-dimensional images in accordance with a processing capability of the display unit.

6. The information processing apparatus according to claim 4, wherein the second processor is configured to execute the instructions to display a list of the second predetermined number of three-dimensional images.

7. The information processing apparatus according to claim 4, further comprising a third processor that is configured to execute the instructions to calculate a score corresponding to a predetermined evaluation criterion for each of the second predetermined number of three-dimensional images, wherein
the second processor is configured to execute the instructions to change a display aspect of each of the second predetermined number of three-dimensional images in accordance with the score.

8. The information processing apparatus according to claim 4, further comprising a fourth processor that is configured to execute the instructions to detect a selection operation of selecting a part of the second predetermined number of the three-dimensional images, wherein
the second processor is configured to execute the instructions to change a display aspect of the three-dimensional image selected by the selection operation.

9. An information processing method comprising:
obtaining an image set including a plurality of images in which a subject is captured;
storing a plurality of image sets;
selecting a first predetermined number of images from across the plurality of image sets; and
generating a three-dimensional image of the subject on the basis of the first predetermined number of images.

10. A non-transitory recording medium on which a computer program that allows a computer to execute an information processing method is recorded, the information processing method including:
obtaining an image set including a plurality of images in which a subject is captured;
storing a plurality of image sets;
selecting a first predetermined number of images from across the plurality of image sets; and
generating a three-dimensional image of the subject on the basis of the first predetermined number of images.
